(19) United States
(12) Patent Application Publication
(10) Pub. No.: US 2007/0109086 A1
(43) Pub. Date: May 17, 2007

(54) Method for forming and testing the formation of amorphous metal objects

(75) Inventors: Tad Rybak, South Australia (AU); John Gayler, South Australia (AU); Steven Kloeden, South Australia (AU); Nesimi Ertugrul, South Australia (AU); Wen Liang Soong, South Australia (AU)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignees: ADELAIDE RESEARCH & INNOVATION PTY LTD, Adelaide (AU); GLASSY METAL TECHNOLOGIES LIMITED, Norwood (AU)

(21) Appl. No.: 10/596,128

(22) PCT Filed: Dec. 2, 2004
(86) PCT No.: PCT/AU04/01680

§ 371 Date: Sep. 20, 2006

(30) Foreign Application Priority Data
Dec. 2, 2003 (AU) 2003906659

(51) Int. Cl. H01F 27/28; H01F 7/06

(52) U.S. Cl. 336/180; 336/221; 29/602.1; 29/593; 29/606

(57) ABSTRACT

A method of forming a portion of magnetic core from a plurality of magnetic ribbons using a former having an electrically conductive coil located about the former has following steps: locating an end of a stack of magnetic ribbon material substantially within the opening of the coil, locating the free end of said stack opposite the first end within the opening of the coil and then applying electric energy to said coil so as to produce a force that draws the ends of said magnetic ribbon towards each other to form the core. Also is disclosed a method for testing for the completion of the assembly of a magnetic core consisting of one or more magnetic ribbons comprising the steps of: measuring one or more electromagnetic characteristics including instantaneous value of the core current and voltage during the process of forming and comparing the said characteristics with a predetermined value.

This invention relates to the construction of ferromagnetic parts for use in electrical circuits, in particular in electromagnetic ballasts, transformers, and inductors where the ferromagnetic material is made from ribbon like strips.

### BACKGROUND

Amorphous magnetic metal (AMM) is a man-made material, which is usually for manufacturing reasons made in the form of ribbon. Molten metal is raised to a high temperature and quenched very quickly to prevent crystallisation while being cooled. One such commercially available product is Metglas™(Hitachi).

Such material in general has the following properties, high permeability, low coercivity, good temperature stability, and low iron losses, operable at high frequencies, high Curie temperature and little or no magnetostriction.

However, this material has high tensile strength and is difficult to cut.

U.S. Pat. No. 6,106,376 is assigned to one of the applicants for this patent. That patent discloses a method for bonding AMM laminations to form a stack. The patent also discloses a method and means for shaping the stack, for example, by cutting, to form a bulk object such as a wound stator or a rotor of an electric motor.

Even if cutting is possible, there are no guidelines available as to how to construct various shapes of AMM for an intended purpose, for example, such as the shape of a magnetic core usable for ballast in an electrical light circuit, or a core for use in transformers and choke elements.

The disclosure in this specification provides selected constructional guidelines and a way of testing the quality of the assembly of the magnetic core that is useable when manufacturing such cores. The methods described are readily useable in a commercial production environment and may use other forms of magnetic material supplied in ribbon form.

### BRIEF DESCRIPTION OF THE INVENTION

In a broad aspect of the invention, a method of forming a portion of a magnetic core from a plurality of magnetic ribbons using a former having an electrically conductive coil located about the former, the former defining an opening in the electrically conductive coil, the method includes the steps of:
a) locating a first end of a stack of magnetic ribbon material substantially within the opening of the electrically conductive coil,
b) locating the free end of said stack of ribbon material opposite said first end within the opening of the electrically conductive coil; and
c) applying electric energy to said electrically conductive coil, so as to produce an electromotive force that draws the ends of said magnetic ribbon material towards each other.

In another aspect of the method of the invention includes the further step:
d) repeating steps a) and b) with on or more further stacks of magnetic ribbon material.

In a further aspect of the invention, the application of electric energy is achieved by discharging an electrical charge storage device for a predetermined time over a predetermined period at least a predetermined number of times.

In a further aspect of the invention, a method for testing for the completion of the assembly of a magnetic core consisting of one or more magnetic ribbons comprises the steps of:
h) measuring one or more electromagnetic characteristics including the instantaneous value of core current and voltage during the process of forming said core according to the method of claim 1;
i) comparing a said characteristic with a predetermined value;
j) continuing steps h) and i) until the comparison falls within a predetermined range.

In a yet further aspect of the method for testing other characteristics include one or more of the following: flux linkage, inductance.

In another aspect of the invention magnetic ballast consists of:
a former having an electrically conductive coil about the former, the former defining an opening in the electrically conductive coil;
one or more non-magnetic and non-conductive spacers located within the opening;
a first stack of magnetic ribbon material having one end of the first stack located within the opening of the electrically conductive coil and close to a spacer and the other end of the first stack located within the opening of the electrically conductive coil and close to a spacer, the other end being opposite the one end of the first stack and the or each spacer spacing apart the ends of the first stack; and
a second stack of magnetic ribbon material having one end of the second stack located within the opening of the electrically conductive coil and close to a spacer and the other end of the second stack located within the opening of the electrically conductive coil and close to a spacer opposite the one end of the second stack and the or each spacer spacing apart the ends of the second stack.

In one aspect of the invention each ribbon in a stack of ribbon material is amorphous magnetic material.

Specific embodiments of the invention will now be described in some further detail with reference to and as illustrated in the accompanying figures. These embodiments are illustrative, and are not meant to be restrictive of the scope of the invention. Suggestions and descriptions of other embodiments may be included within the scope of the invention, but they may not be illustrated in the accompanying figures. Alternatively features of the invention may be shown in the figures but not described in the specification

### BRIEF DESCRIPTION OF THE FIGURES

FIG. 1 depicts a shape of a ballast core for use in a lighting circuit made of AMM ribbon;

FIG. 2 depicts fully constructed magnetic ballast made from AMM and various other parts;

FIG. 3 depicts a stack of AMM ribbons ready for insertion in a former for making magnetic ballast;

FIG. 4 depicts two ends of the AMM ribbons positioned in a former;

FIG. 5 depicts partially constructed magnetic ballast;

FIG. 6 depicts a capacitor discharging circuit used in the construction of magnetic ballast;

FIG. 7 depicts sample voltage, current, flux linkage and inductance waveforms used to compare like waveforms generated during the construction of a magnetic ballast made of AMM; and

FIG. 8 depicts the flow of an embodiment of the testing method.

### DETAILED DESCRIPTION OF EMBODIMENTS OF THE INVENTION

By way of example, only the manufacture of ballast for use in a lighting circuit using ribbons of AMM will be described in detail herein. The general techniques disclosed however, may have use in the construction of other articles, for example, transformers and chokes to name but a few, using magnetic material of supplied in ribbon form such as AMM or others.

Disclosed in this specification is a method for assisting the construction of the element made of magnetic ribbon material and in a preferred embodiment AMM, and also a method for testing the quality of the assembly during construction of that element.

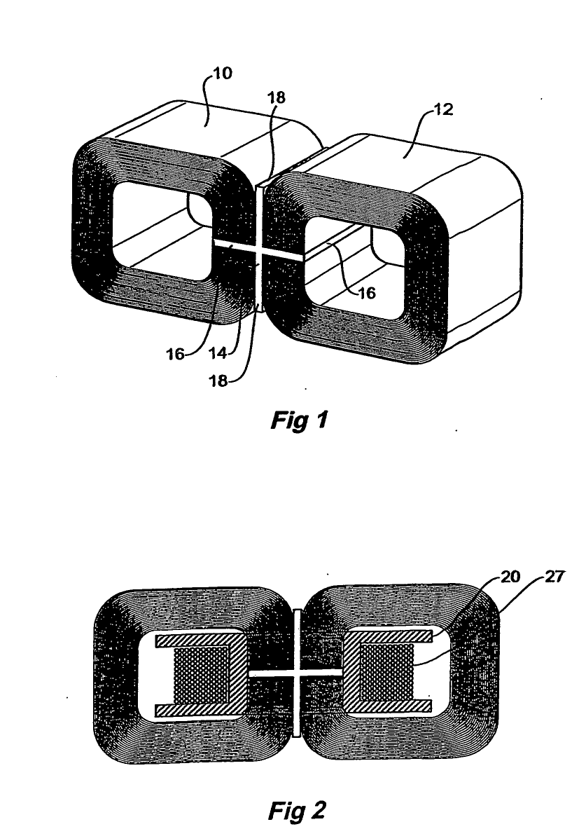

FIG. 1 depicts a perspective view of one embodiment of an aspect of the invention being the shape of a ballast core comprising two substantially square or c-shaped hollow forms (10, 12). Current carrying wires are not shown on the ballast core (as is shown in cross-section in FIG. 2).

Opposite ends of the ribbons forming each c-shaped hollow portions of the core abut and are spaced apart by horizontal arms (16) of a cross-shaped spacing assembly 14. While the vertical arms (18) of the cross-shaped spacing member abut and space apart the opposite ends of each c-shaped hollow form from the other. The spacing assembly may be unitary or made up of two or more parts.

FIG. 2 depicts a cross-sectional view of the shape of a ballast core including the elements of FIG. 1 plus a non-conductive former 20 and the wire windings in cross-section 27. The former defines an opening 30 in the coil of wire windings that have been wound about the former. In the manufacture of the ballast although it would be more difficult to do it could be possible to wind the coil of wire after the ends of the forms are located in the opening 30. However, it is best if the former is already wound with the coil. The magnetic material of the ballast is designed to have predetermined gap typically occupied by a spacing assembly 14 (at the locations described and shown for FIG. 1).

The c-shaped hollow forms (10, 12) are made of several hundred ribbons of magnetic material, preferably of micrometer thick AMM. The term ribbon is used in its most general sense as it provides a convenient label for the currently manufactured form of AMM but can equally represent other similar forms of ribbon magnetic material suitable for formation of such a magnetic core.

There exist cutting arrangements that can provide orthogonal or sloped cuts along the face of the stacked ribbon or along the side profile of the stacked ribbon. By way of example, the method and means disclosed in U.S. Pat. No. 6,106,376 can be used to form the ends of the ribbons, but is not necessarily the only method of forming the shape of a ribbon or a stack of ribbon.

Each AMM ribbon needs to be pre-formed to allow for an inner ribbon in a c-shaped hollow form to be shorter than an outer ribbon. This can be done to lengths as determined by experiment or calculation.

Any required final cutting of the ends of the ribbon that will eventually be located adjacent but separated by the spacer is done once the step below is completed. During the cutting process, which may use water or a non-corrosive liquid as a carrier, it is possible for contamination to occur on and between ribbons. A cleaning and drying process can be performed if required. This could consist of the following process.

The clamps 40 are released and all the ribbons are cleansed in an alcohol bath. Alcohol will readily carry away contaminants but then dry without residue at room temperature.

Care is taken not to put any of the ribbons in the stack out of order.

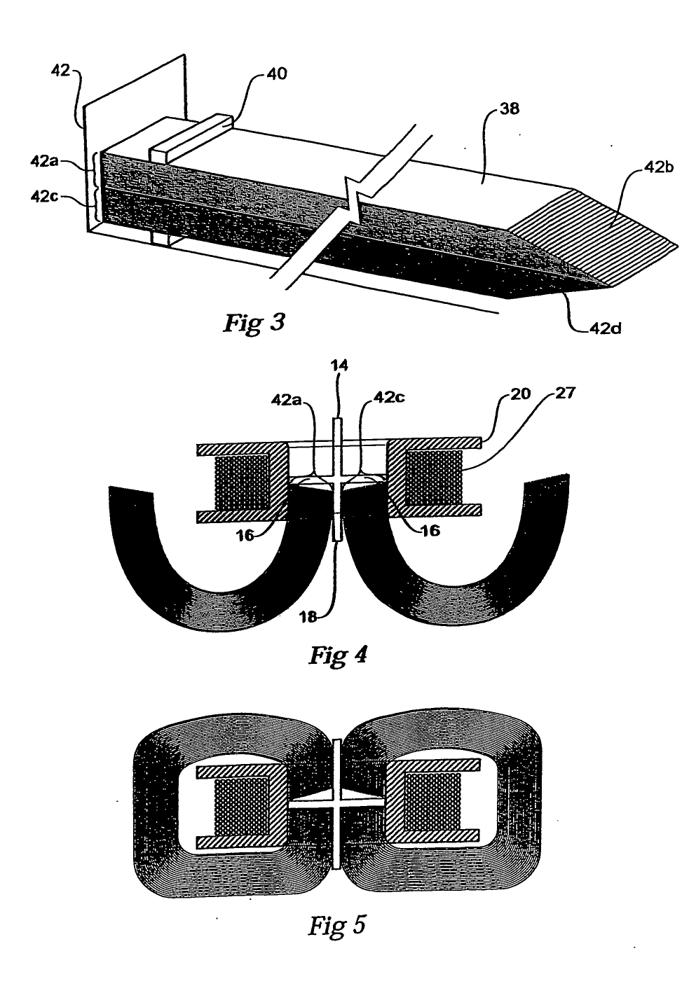

To realign one end of the stack of ribbons an alignment jig 42 can be used as illustrated in FIG. 3.

FIG. 3 depicts the cut ribbons 38 loosely clamped 40 at one end in an alignment jig 42. Gently tapping the ends forms the ends into a single plane which is preferably at right angles to the plane of the ribbons. This step in the process can be readily done manually, judging by eye the conformity of the ends to a common plane. Clearly such a step could be mechanised and a laser or other alignment testing tools could be used to test conformity of the ends to a required flatness.

Eventually, once the stack of ribbons is made into the c-shaped form, the top half of the ribbons 42a will be made to become adjacent to the now shaped end 42b. Likewise with respect to the bottom half 42c of the other stack of ribbons, it will become adjacent to the now shaped end 42d.

Ribbons have now been formed into a shape capable of being folded into two adjacent substantially c-shaped cores as depicted in FIG. 2. The cores once combined with other elements can act in this embodiment as magnetic ballast for lighting devices.

FIG. 4 shows the two ends 42a and 42c separated and spaced apart by lower arm 18 of the spacer 14 (cross-shaped member) and the flat ends of one or more of the ribbons of each stack abutting the lower surface of arms 16. Not all the ends of the ribbons in each stack will necessarily be able to abut the lower surface of the arms 16, which means that the end of the stack is substantially located in the opening of the coil 27.

The coil is constructed in a known way, typically by winding a single wire multiple times about the former 20, thereby defining an opening 30. The opening is located centrally of the coil and is also the location of one or more spacers, which in this embodiment is a unitary cruciform shaped member 14.

The proximity of the end of the stack to the arms 16 is not critical at this time although it is preferable for abutment between the ends of each ribbon against the spacer to be achieved. Any lack of conformity will be adjusted when the following further steps are completed. The end of the stack of ribbons then located within the opening 30 of the coil 27 so that when the coil is energised the ribbons in the stack will be within the strongest portion of the electromagnetic field created by the energised coil.

Spacer 14 is located within the former 20 pre-wound with wires 27 as described previously. The arms 16 of spacer 14 will provide the required air gap between the ends of the coiled stack of ribbons. The spacer 14 is made of a non-conducting non-magnetic material so as to minimize attenuation of the magnetic flux passing across the air gap between the ends of the ribbons.

Having a spacer located in a former is new, since a method of creating magnetic ballast as described herein has not been used previously.

The next stage of the forming process involves bending one of the stacks of formed AMM ribbon around the former 20. The free ends of the ribbons are inserted into the gap between the upper arm 18 of the spacer and the sides of the former and into the opening of the coil 27. The arm 18 of spacer 14 serves to guide the insertion of the ends of the cut ribbons. FIG. 5 displays this step partially completed. FIG. 5 also shows the first end of the stacker perfectly abutting the underside of the spacer; however, this may not always be practically achievable.

Not surprisingly, folding and positioning the free end of the stack is a physically difficult step in the process as the ribbons are not always fully compacted together and the space between former 20 and the vertical arm 18 of the space 14 is sized for compacted ribbons.

The frictional sliding forces between adjacent ribbons start to build up and multiply as the folding continues, and exerting pressures only on the outer ribbons causes uneven pressure on the bundle of ribbons itself. The uneven air gap shown in FIG. 5 is not acceptable and ideally, the final product should resemble that depicted in FIG. 2.

An uneven array of ends of the ribbons in the finished product may adversely affect the inductance and other electromagnetic characteristics of the magnetic ballast. However, perfect alignment is not necessarily practically possible.

The final step of the process replaces physical forces applied to the outer ribbons with an electrical energy discharge to a coil that produces a magnetic field that induces an attraction between the formed ends of the ribbons that moves the ribbons into place.

A large current (compared to the rated current of the ballast) is applied to the windings 22 of the ballast for a short period of time (1-10 ms).

The current generates a magnetic force of attraction between the two ends of the stack of ribbons as well as individual ribbons.

The magnetic attraction forces are great enough to overcome the mounting frictional resistance forces mentioned previously and the two free ends 42b and 42d of the stack 15 ribbons are drawn towards the two fixed ends 42a and 42c respectively.

Repeated applications of electromagnetic force may be required until the ribbon ends are substantially adjacent the upper surface of arm 16 producing a substantially uniform gap that can be verified automatically by measuring the inductance of the winding or other measurement techniques as suitable.

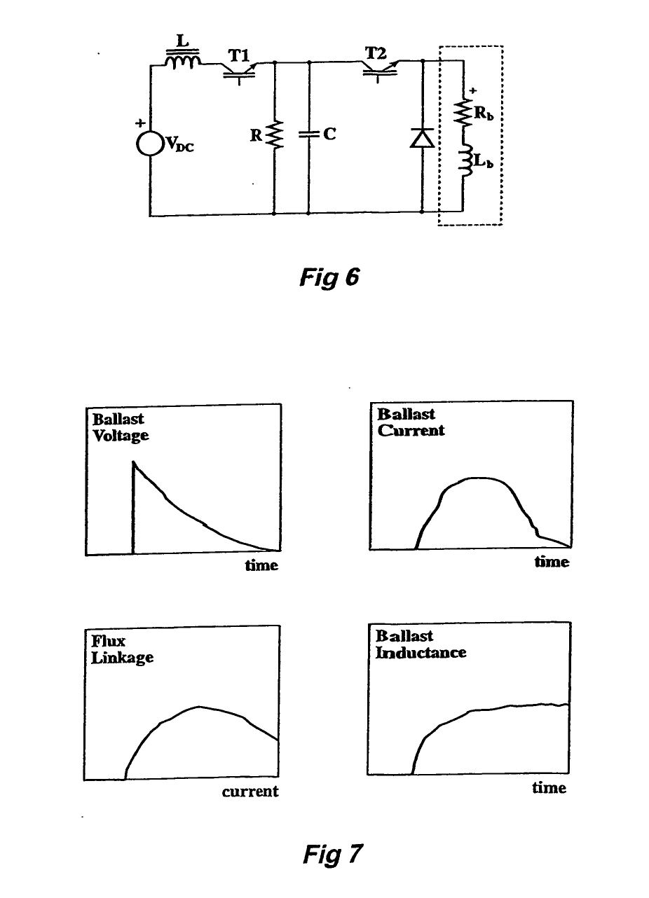

FIG. 6 depicts one embodiment of a circuit providing the energising current pulse described above.

In FIG. 6 the device under test represents the equivalent circuit of the winding of the ballast (Lb, Rb), T1 is the charging control switch and T2 is the discharge control switch. C is a unipolar capacitor that stores electric energy. R is the bleed resistor, and L is a choke that limits the initial charging current of the capacitor and also reduces the current rating of the input rectifier shown as V_{dc}. The diode across the winding is a freewheeling diode.

When T1 is switched on, this device receives electrical energy from the mains power supply from rectifier (V_{dc}) and stores it in a large capacitor C.

When the capacitor is fully charged, switch T1 is switched off and T2 is switched on which allows the current to flow as a pulse through the ballast winding. This generates a large electromotive force that attracts the ends of the ribbons together.

It is predicted that the rated current and voltage of the capacitor will be about 400 to 1000V and 40-50 A respectively (for a 240V, 1 A ballast). The capacitors are in the range of 10,000 μF and their specification for use in a high voltage discharge application is critical.

To achieve an acceptably high voltage, more than one capacitor may be connected in series. However, in practice this can increase the total internal resistance, which may absorb some of the discharge energy instead of delivering that energy to the winding. Therefore, the design of the multiple capacitor arrangement should consider such adverse affects.

As it is not always accurate or even sufficient to visually inspect the success of this step of the process, ie to ensure that the air gap formed is substantially uniform, a repeatable and accurate testing technique has been developed.

The principle of electrically testing the formulation of the ends of the ballast core is based on directly measuring the instantaneous values of ballast current and voltage during the above capacitive discharge process. Data acquisition systems and software is required to use the following information.

Voltage across the ballast winding can be given in the formula

$${v}_{b} ( t ) = {R}_{b} {i}_{b} ( t ) + \frac{ⅆ {ψ}_{b} ( t )}{ⅆ t}$$

where v_{b}(t) is the instantaneous voltage, i_{b}(t) is the instantaneous current through the winding, and ψ_{b}(t) is the instantaneous flux linkage of the winding. Therefore at any instance of time, the flux linkage characteristic of the ballast can be determined by integrating the above equation over a time period. If the total voltage drop of the external components and the value of the initial flux linkage are included, the general flux linkage equation per phase can be given by

$${ψ}_{b} ( t ) - {ψ}_{b} ( 0 ) = {\int }_{0}^{t} [ v ( t ) - Δ v - {i}_{b} ( t ) {R}_{b} ] ⅆ t$$

Where Rb is the winding resistance, Δv is the total voltage drop including the switching device and connections, dt is the time interval, and ψ_{b}(o) is the initial value of the flux linkage.

The above integration will be performed by the software, which determines the following characteristic about the ballast referring to FIG. 7. The characteristic waveforms obtained can then be used to verify the correctness of the assembly process. Software and associated hardware provides a fully automated assembly and electrical testing system, which can be used in a production line for creating magnetic ballasts of the type described. Similar calculations can be used to determine an arrangement when making other devices with the described type of magnetic core.

Once the gap is made substantially uniform the ends can be damped into position by any convenient means and the magnetic ballast is ready for inclusion in a lighting device. The use of AMM in the ballast will decrease power consumption in comparison to all existing devices and it may be possible that other magnetic ribbon material will have the capability to also reduce power consumption in the same and like devices.

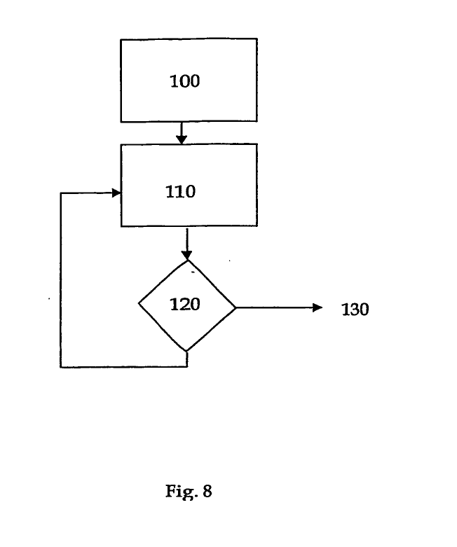

The method of testing the formation of the magnetic core of any device is pictorially illustrated in FIG. 8 where the process of discharging 100 current in the winding of the magnetic core device, is followed but practically almost concurrent with the discharge set of measurement 110 of one or more electromagnetic characteristics including the instantaneous value of core current and voltage. The next step also typically and practically concurrent with the earlier steps, is of comparing 120 the measured characteristic with the predetermined values as represented by the graphical representations of FIG. 7, and continuing steps 100, 110 and 120 until the comparison falls within a predetermined range for a particular characteristic, as can be readily determined by a person skilled in the art, and then stopping the process 130.

This is but one example of the construction and testing method of aspects of the invention, as transformers and other magnetic core devices requiring similar assembly can be made according to the aspects of the invention described herein.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications in its scope.

1. A method of forming a portion of magnetic core from a plurality of magnetic ribbons using a former having an electrically conductive coil located about the former, the former defining an opening in the electrically conductive coil, the method consists of the steps:
a) locating a first end of a stack of magnetic ribbon material substantially within the opening of the electrically conductive coil,
b) locating the free end of said stack of ribbon material opposite said first end within the opening of the electrically conductive coil; and
c) applying electric energy to said electrically conductive coil, so as to produce an electromotive force that draws the ends of said magnetic ribbon material towards each other.

2. A method according to claim 1 including the further steps:
d) repeating steps a) and b) with a further stack of magnetic ribbon material.

3. A method according to claim 1 wherein a step prior to step a) consists of:
e) pre-forming a magnetic ribbon material to a length that allows the ends of each ribbon to be located opposite one another when those ends are located adjacent each other in the opening of the coil, to thereby form a non-continuous loop of ribbon material.

4. A method according to claim 1 wherein a step prior to step a) consists of:
f) pre-forming a stack of ribbons of magnetic ribbon material to a predetermined shape that allows the ends of the stack to be located opposite one another when those ends are located adjacent each other in the opening of the coil, to thereby from a non-continuous loop of stacked ribbon material of substantially uniform thickness.

5. A method according to claim 1 wherein the electrically conductive coil includes a single coil of wire looped multiple times about the former.

6. A method according to claim 1 wherein the former is non-conductive and non-magnetic.

7. A method according to claim l wherein at least one spacer used with the former is sized so as to create a predetermined gap between opposite ends of the stack of ribbon material when located in the opening after step c).

8. A method according to claim 7 wherein the spacer is non-conductive and non-magnetic.

9. A method according to claim 8 wherein the spacer is cruciform shaped in cross-section.

10. A method according to claim 1 wherein each spacer is non-conductive and non-magnetic.

11. A method according to claim I further including the step of:
g) annealing the coil formed out of the stack of magnetic ribbons.

12. The method of claim 1 wherein the application of electric energy is achieved by discharging an electrical charge storage device for a predetermined period at least a predetermined number of times into the coil.

13. The method according to claim 12 wherein the electrical charge discharge is at least twice as great as the current level usable by the device created by the method.

14. The method according to claim 12 wherein the predetermined period is between 1 and 10 milliseconds.

15. The method according to claim 12 wherein the predetermined number of times is between 1 and 4.

16. A method according to claim 1 wherein each ribbon in a stack of ribbon material is amorphous magnetic material.

17. A method for testing for the completion of the assembly of a magnetic core consisting of one or more magnetic ribbons comprises the steps of:
h) measuring one or more electromagnetic characteristics including the instantaneous value of core current and voltage during the process of forming said core according to the method of claim 1;
i) comparing a said characteristic with a predetermined value;
j) continuing steps h) and i) until the comparison falls within a predetermined range.

18. A method for testing in accordance with claim 16 wherein other electromagnetic characteristics include one or more of the following: flux linkage, inductance.

19. Magnetic ballast consisting of:
a former having an electrically conductive coil about the former the former defining an opening in the electrically conductive coil;
one or more non-magnetic and non-conductive spacers located within the opening;
a first stack of magnetic ribbon material having one end of the first stack located within the opening of the electrically conductive coil and the other end of the first stack located within the opening of the electrically conductive coil, the other end being opposite the one end of the first stack and the or each spacer spacing apart one or more opposite ends of the magnetic ribbon material forming the first stack; and
a second stack of magnetic ribbon material having one end of the second stack located within the opening of the electrically conductive coil and the other end of the second stack located within the opening of the electrically conductive coil opposite the one end of the second stack and the or each spacer spacing apart one or more of opposite ends of the magnetic ribbon material forming the second stack.

20. Magnetic ballast according to claim 19 wherein each ribbon in a stack of ribbon material is amorphous magnetic material.

21. Magnetic ballast according to claim 19 wherein the electrically conductive coil includes a single wire looped multiple times about the former.

22. Magnetic ballast according to claim 19 wherein the former is non-conductive and non-magnetic.

23. Magnetic ballast according to claim 19 wherein the spacer is sized to create a predetermined gap between opposite ends of the same stack of magnetic ribbon material.

24. Magnetic ballast according to claim 19 wherein the spacer is non-conductive and non-magnetic.

25. Magnetic ballast made according to claim 1.
